(19) United States
(12) Patent Application Publication
(10) Pub. No.: US 2021/0021745 A1
(43) Pub. Date: Jan. 21, 2021

(54) AUTOMOTIVE LAMINATE WITH EMBEDDED CAMERA

(71) Applicant: AGP America S.A., Ciudad de Panama (PA)

(72) Inventors: Mario Arturo MANNHEIM ASTETE, Lima (PE); Laura GRANADOS CARO, Lima (PE)

(21) Appl. No.: 17/043,127

(22) PCT Filed: Mar. 30, 2019
(86) PCT No.: PCT/IB2019/052640

§ 371 Date: Sep. 29, 2020

Related U.S. Application Data
(60) Provisional application No. 62/650,390, filed on Mar. 30, 2018.

(51) Int. Cl. H04N 5/225; B32B 17/10

(52) U.S. Cl. CPC H04N 5/2257; B32B 17/10036; B32B 2605/00; B32B 17/10165; B32B 17/10761

(57) ABSTRACT

The increase in the electronic content of automotive glazing has expanded, from just components mounted to the glass, to components which are an integral permanent part of the glass. One component, which is becoming more and more common, is the camera. The use of camera-based safety systems, requiring a wide field of view and a high level of optical clarity, is growing at a rapid rate. As the industry moves towards full autonomous capability, the number of cameras and the resolution of the cameras are both increasing. At the same time, windshields, where many of the cameras are mounted, are becoming larger and more complex in shape. The windshield, as an integral part of the camera lens system, is less than optimal. The light has to pass through layers of glass and plastic leading to distortion, attenuation, color shift and double image as well as calibration issues. The effects of the windshield on the optical quality are mitigated by the invention by integrating the camera into the laminate.

### FIELD OF THE INVENTION

This invention relates to the field of laminated automotive glazing.

### BACKGROUND OF THE INVENTION

The use of camera-based safety systems, requiring a wide field of view and a high level of optical clarity, is growing at a rapid rate. As the industry moves towards full autonomous capability, the number of cameras and the resolution of the cameras are both increasing. At the same time, windshields, where many of the cameras are mounted, are becoming larger and more complex in shape.

The main cameras require a high, forward looking field of view and so must typically be mounted on the windshield and in the area cleared by the wipers. Camera based systems are used to provide a wide array of safety functions including adaptive cruise control, obstacle detection, lane departure warning and support for partial and full autonomous operation. Many of these applications require the use of multiple cameras. A clear undistorted field of view, with minimal double imaging, a high level of light transmission with unaltered natural color is especially critical for camera-based systems to perform as intended. It is essential for these systems to be able to quickly differentiate between objects, capture text, identify signage, and operate with minimal lighting. Further, as the resolution of the cameras increases, the need for a clear distortion free field of view increases.

The optical quality of windshields is based upon the requirements for human vision. However, the human eye can analyze and filter an image far better than a computer. Knowing that, nevertheless, today's cameras have far greater resolution than the human eye. This means that the requirements of human vision are not the same as for a camera system. In general, for computer vision, the optical requirements are more like that of a precision lens system than a human eye. This may change in the future but for now and the foreseeable future, the optical quality of windshield will need to be better than required for just human vision.

The traditional laminated windshield has several drawbacks when it becomes a part of the camera lens system. The two glass layers of the laminate, bonded together with a sheet of plastic interlayer, each reflect. The multiple reflections produce a double image which reduces the precision of the camera system.

Windshields are typically manufactured using a solar control glass composition, interlayer, film or coating. These products, while very good at reducing the solar load on a vehicle, result in losses of intensity due to reflection, refraction and absorption. They also shift the natural color of the light. Due to the color shift, silver based solar control coatings and films need to be removed from the glass for the camera systems to work.

Anytime that light passes through glass, the glass acts as a lens. The two glass layers of the windshield will always have some optical power. However, the optical power is not uniform across the camera field of view due to variations in curvature that result from the normal process variation in both the flat float glass and the bent glass.

This variation in optical quality, from windshield to windshield causes calibration problems. A camera system transferred from one windshield to another replacement windshield needs to be recalibrated to compensate for the variation.

It would be desirable overcome these limitations by providing a superior method for making electrical connection in laminated glazing.

### BRIEF SUMMARY OF THE INVENTION

A thin camera system is embedded/laminated in a laminated window for decreasing the effect of glass/interlayer/glass optical power and distortion. The present invention solves calibration problems due to optical quality variation from window to window and diminishes the losses due to refraction, reflection and transmission caused by materials like interlayers and coatings.
Decrease optical power and distortion and hence improving the performance
Solves calibration problems due to optical quality variation from window to window
Diminishes the losses due to refraction, reflection and transmission caused by materials like glass interlayers and coatings
Allows for the use of a solar control coating or composition for the inner glass layer.
Allows for the use of a solar control interlayer.
Decreases the light path (due to less thickness in front of the camera)

### BRIEF DESCRIPTION OF THE SEVERAL VIEWS OF THE DRAWINGS

FIG. 1A shows a cross section of a typical automotive laminate.

FIG. 1B shows a cross section of a typical automotive laminate with coating and performance film.

FIG. 2 shows an exploded view: windshield with embedded camera system.

FIG. 3A shows a top view: embedded camera system.

FIG. 3B shows an isometric view of the embedded camera system.

### REFERENCE NUMERALS

2 Glass
4 Bonding layer (plastic Interlayer)
6 Black Paint
8 Lens
12 Film
14 Flexible Circuit
16 Camera
18 Coating
24 Hole
32 Camera Assembly
101 Exterior side of glass layer 1, number one surface.
102 Interior side of glass layer 1, number two surface.
103 Exterior side of glass layer 2, number 3 surface.
104 Interior side of glass layer 2, number 4 surface.
201 Vehicle exterior layer
202 Vehicle interior layer

### Detailed Description of the Invention

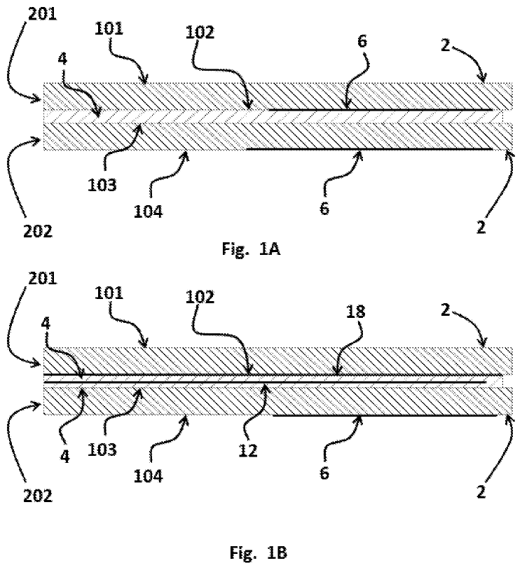

The following terminology is used to describe the laminated glazing of the invention. A typical automotive laminate cross section is illustrated in FIGS. 1A and 1B. The laminate is comprised of two layers of glass 2, the exterior or outer 201, and interior or inner 202 that are permanently bonded together by a plastic layer 4 (interlayer). The glass surface that is on the exterior of the vehicle is referred to as surface one 101 or the number one surface. The opposite face of the exterior glass layer 201 is surface two 102 or the number two surface. The glass 2 surface that is on the interior of the vehicle is referred to as surface four 104 or the number four surface. The opposite face of the interior layer of glass 202 is surface three 103 or the number three surface. Surfaces two 102 and three 103 are bonded together by the plastic layer 4. An obscuration 6 may be also applied to the glass. Obscurations are commonly comprised of black enamel frit printed on either the number two 102 or number four surface 104 or on both. The laminate may also comprise a coating 18 on one or more of the surfaces. The laminate may also comprise a film 12 laminated between at least two plastic layers 4.

The plastic bonding layer 4 (interlayer) has the primary function of bonding the major faces of adjacent layers to each other. The material selected is typically a clear thermoset plastic. For automotive use, the most commonly used bonding layer 4 (interlayer) is polyvinyl butyral (PVB). PVB has excellent adhesion to glass and is optically clear once laminated. It is produced by the reaction between polyvinyl alcohol and n-butyraldehyde. PVB is clear and has high adhesion to glass. However, PVB by itself, it is too brittle. Plasticizers must be added to make the material flexible and to give it the ability to dissipate energy over a wide range over the temperature range required for an automobile. Only a small number of plasticizers are used. They are typically linear dicarboxylicesters. Two in common use are di-n-hexyl adipate and tetra-ethylene glycol di-n-heptanoate. A typical automotive PVB interlayer is comprised of 30-40% plasticizer by weight.

In addition to polyvinyl butyl, ionoplast polymers, ethylene vinyl acetate (EVA), cast in place (CIP) liquid resin and thermoplastic polyurethane (TPU) can also be used. Automotive interlayers are made by an extrusion process with has a thickness tolerance and process variation. As a smooth surface tends to stick to the glass, making it difficult to position on the glass and to trap air, to facilitate the handling of the plastic sheet and the removal or air (deairing) from the laminate, the surface of the plastic is normally embossed contributing additional variation to the sheet. Standard thicknesses for automotive PVB interlayer at 0.38 mm and 0.76 mm (15 and 30 mil). From the vessel into a thin ribbon on the flat glass float line.

A wide variety of films are available that can be incorporated into a laminate. The uses for these films include but are not limited to: solar control, variable light transmission, increased stiffness, increased structural integrity, improved penetration resistance, improved occupant retention, providing a barrier, tint, providing a sunshade, color correction, and as a substrate for functional and aesthetic graphics. The term “film” shall include these as well as other products that may be developed or which are currently available which enhance the performance, function, aesthetics or cost of a laminated glazing. Most films do not have adhesive properties. To incorporate into a laminate, sheets of plastic interlayer are needed on each side of the film to bond the film to the other layers of the laminate.

The types of glass that may be used include but are not limited to: the common soda-lime variety typical of automotive glazing as well as aluminosilicate, lithium aluminosilicate, borosilicate, glass ceramics, and the various other inorganic solid amorphous compositions which undergo a glass transition and are classified as glass included those that are not transparent. The glass layers may be comprised of heat absorbing glass compositions as well as infrared reflecting and other types of coatings. Additionally, for infrared cameras or when a high transmission is needed after 2.5 um, the portion of glass in front of the camera can be oxygen free including but not limited to chalcogenides, heavy metal halides or high-density polymers that do not absorb infrared waves between 2.5 um and 20 um (not shown in figures).

Most of the glass used for containers and windows is soda-lime glass. Soda-lime glass is made from sodium carbonate (soda), lime (calcium carbonate), dolomite, silicon dioxide (silica), aluminum oxide (alumina), and small quantities of substances added to alter the color and other properties.

Annealed glass is glass that has been slowly cooled from the bending temperature down through the glass transition range. This process relieves any stress left in the glass from the bending process. Annealed glass breaks into large shards with sharp edges. When laminated glass breaks, the shards of broken glass are held together, much like the pieces of a jigsaw puzzle, by the plastic layer helping to maintain the structural integrity of the glass. A vehicle with a broken windshield can still be operated. The plastic layer 4 also helps to prevent penetration by objects striking the laminate from the exterior and in the event of a crash occupant retention is improved.

The glass layers may be annealed or strengthened. There are two processes that can be used to increase the strength of glass. They are thermal strengthening, in which the hot glass is rapidly cooled (quenched) and chemical tempering which achieves the same effect through an ion exchange chemical treatment.

A panoramic windshield is a windshield on which the top edge has been substantially extended such that it comprises a portion of the vehicle roof.

A panoramic roof is a vehicle roof glazing which comprises a substantial area of the roof over at least a portion of both the front and rear seating areas of the vehicle. A panoramic roof may be comprised of multiple glazings and may be laminated or monolithic.

The glass layers are formed using gravity bending, press bending, cold bending or any other conventional means known in the art. In the gravity bending process, the glass flat is supported near the edge of glass and then heated. The hot glass sags to the desired shape under the force of gravity. With press bending, the flat glass is heated and then bent on a full of partial surface mold. Air pressure and vacuum are often used to assist the bending process. Gravity and press bending methods for forming glass are well known in the art and will not be discussed in detail in the present disclosure.

Laminates, in general, are articles comprised of multiple sheets of thin, relative to their length and width, material, with each thin sheet having two oppositely disposed major faces and typically of relatively uniform thickness, which are permanently bonded to one and other across at least one major face of each sheet.

Laminated safety glass is made by bonding two sheets (201 & 202) of annealed glass 2 together using a plastic bonding layer comprised of a thin sheet of transparent thermos plastic 4 (interlayer) as shown in FIG. 1.

As a general rule of thumb, a component can be laminated if the thickness is no more than ⅓ of the total thickness of the interlayer. During the lamination process, the interlayer is treated at an elevated temperature and will at least partially flow to accommodate the component. The maximum thickness will depend upon other factors such as the other dimensions of the object, the thickness of the glass, the strength of the glass, the specific interlayer and the time, temperature and pressure of the lamination cycle. If the component is too thick, the glass may break. Objectionable distortion can also occur. With all other factors remaining the same, thinner is always better with respect to the risk of breakage and distortion.

The electronics industry has made great progress in reducing both the cost of and dimension of cameras. High definition video capture can be done with an image sensor having a very small footprint and profile. Image processing, communications and other functions are often performed on the same chip or chip set as the image sensor. Thin single chip cameras are increasingly being embedded in phones, notebooks, laptops and other electric devices where they are used to provide many functions.

It is now possible to produce a single chip camera system that is thin enough and sufficiently durable to incorporate into a laminated automotive glazing. A single chip camera with integrated processing and communications can be fitted with a high refractive index lens and mounted to a flexible printed circuit and still be thin enough to fit between the glass layers of a standard windshield. There is available at least 0.76 mm, between the glass layers and as much as 2 mm when other layers are added as is common practice when laminating a performance film as a part of the laminate. This is too thick to laminate without altering the interlayer.

To accommodate, the present invention provides a laminate glazing with a hole that is cut in one or more of the interlayers sized to fit the camera system. The flexible circuit can be designed to include a lead for the power and signal connection. The lead can be taken out from the laminate at the edge of glass or through the hole in the inner glass 202 layer.

The term hole, as used, applies to any perforation or opening through and in at least one of the glass layers. The shape of hole is not limited to circular but may be of any other shape including but not limited to rectangular and oval.

In the some embodiments of the invention, a LASER is used to cut an opening through the inner glass layer in an area outside of the camera field of view. Methods of LASER cutting and drilling through glass are known in the art. A nanosecond pulsed LASER or preferably a femtosecond pulsed LASER is used in conjunction with an optical means with provides a focal point that is at or below the exterior surface of the glass. As the glass is removed by the LASER the focus is adjusted or the LASER itself is moved to deepen the opening. In this manner, holes with low surface roughness can be produced. Surface roughness is important as it is a measure of the quality of the glass surface. A smoother surface has fewer and less severe surface defects. A smoother surface has a lower probability of breakage. A hole can be produced wherein the face of the hole and edges have a surface roughness of less than 2 um, orders of magnitude better than the best that can be achieved by traditional grinding.

Rather than leaving the abraded edges and surface of the hole exposed, a material is used to fill and seal the hole. The UV cured resins commonly used for windshield repair work well. However, as can be appreciated, there are many other materials that can be used including those which are not transparent and those with various other cure mechanisms. The primary properties include good adhesion to the glass and the ability to serve as a moisture barrier. Unless the coefficient of thermal expansion is close to that of glass, the material must also remain pliable at low temperatures so as to not create stress in the glass.

In additional embodiments, it is possible to design a camera system that is wireless allowing for all of the components to be laminated inside of the glass. This may be beneficial in the case of large panoramic parts where the connectors would need to run a great distance or where it is undesirable to cut a hole. Power can be provided through inductive transfer. Inductive charging of cell phones and other electronic devices is well known in the art. The images from the camera in a similar manner can be transfers by wireless transfer, another well developed and understood technology.

### DETAILED DESCRIPTION OF THE EMBODIMENTS

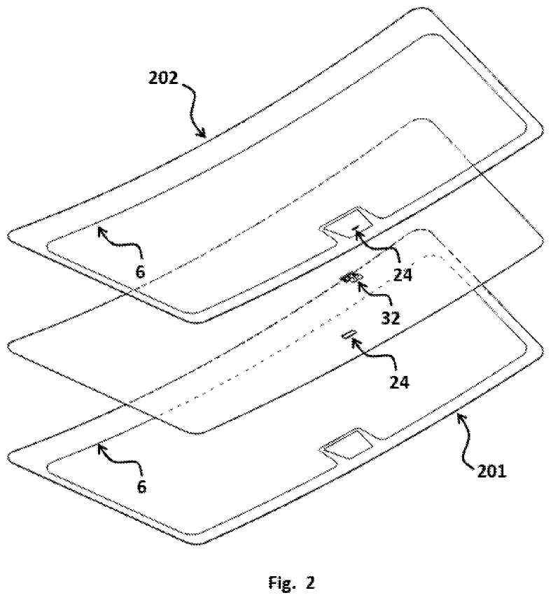

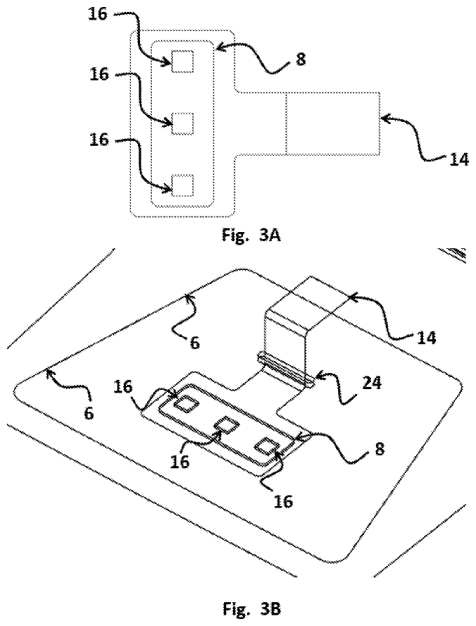

1. The windshield, illustrated in FIG. 2, is comprised of an outer glass layer 201 of clear soda-lime glass of 2.3 mm thickness, an inner glass layer 202 of solar green soda-lime glass of 2.1 mm thickness, and an intermediate layer 4 of PVB having a thickness of 1.5 mm. A hole 24 of 20 mm×50 mm is cut in the PVB layer, sized to accommodate the camera system. Similarly, a hole 24 of 2 mm in width by 15 mm in length is created in the flat inner glass layer 202, prior to bending, using a femto-second LASER. The walls of the hole produced have a surface smoothness of <2 um. The two glass layers are gravity bent to shape. During assembly of the laminate, a camera system, shown in FIGS. 3A and 3B, comprising three 6 mm×6 mm image sensor chips mounted to a thin flexible circuit and incorporating a high refractive index lens 8, having a total thickness of 1.2 mm is placed in the hole 24 in the PVB with an optical adhesive used to bond the lens to the glass surface. The flexible circuit lead is threaded through the slot as the laminate is assembled. A standard laminating process is used to laminate the assembly. After lamination, the hole is filled with a resin commonly used to repair cracks and chips in windshields, the air is evacuated from the hole, that the resin in cured by means of UV light.

2. A windshield, similar to the one illustrated in FIG. 2, is comprised of an outer glass layer 201 of clear soda-lime glass of 2.3 mm thickness, an inner glass layer 202 of solar green soda-lime glass of 2.1 mm thickness, and an intermediate layer 4 of PVB having a thickness of 1.5 mm. A hole 24 of 20 mm×50 mm is cut in the PVB layer, sized to accommodate the camera system. An inductive pickup loop comprised of 0.2 mm copper wire is embedded in the PVB. During assembly of the laminate, a camera system, shown in FIGS. 3A and 3B, comprising three 6 mm×6 mm image sensor chips mounted to a thin flexible circuit and incorporating a high refractive index lens 8, having a total thickness of 1.2 mm is placed in the hole 24 in the PVB with an optical adhesive used to bond the lens to the glass surface. The inductive pickup loop is connected to the camera system. A standard laminating process is used to laminate the assembly. After lamination, the hole is filled with a resin commonly used to repair cracks and chips in windshields, the air is evacuated from the hole, that the resin in cured by means of UV light. The camera system is controlled by and transfers data by a wireless means and is powered by an inductive power transfer system.

It must be understood that this invention is not limited to the embodiments described and illustrated above. A person skilled in the art will understand that numerous variations and/or modifications can be carried out that do not depart from the spirit of the invention, which is only defined by the following claims.

What is claimed is:

1. A laminated automotive glazing, comprising:
an outer glass layer;
an inner glass layers;
at least one plastic interlayer between the outer and inner glass layers;
at least one camera system, wherein the camera system is laminated between the glass layers as an integral permanent part of the laminate.

2. The laminate of claim 1 wherein the camera system comprises at least one image sensor.

3. The laminate of claim 1 wherein the camera system comprises at least one lens.

4. The laminate of claim 1 wherein the camera system comprises wireless communications means.

5. The laminate of claim 1 wherein the camera system comprises wireless powering means.

6. The laminate of claim 1 further comprising at least one hole in the inner glass layer provided to route the camera electrical connecting means.

7. The laminate of claim 6 wherein the hole in the assembled laminate is sealed.

8. The laminate of claim 7 wherein the sealing means has good adhesion to glass.

9. The laminate of claim 7 wherein the sealing means blocks moisture.

10. The laminate of claim 7 wherein the sealing means remains pliable at low temperatures.

11. The laminate of claim 7 wherein the sealing means has a coefficient of thermal expansion that is within 50% of the glass.
